(19) United States
(12) Patent Application Publication
(10) Pub. No.: US 2015/0152675 A1
(43) Pub. Date: Jun. 4, 2015

(54) HINGE FOR DOORS OF DOMESTIC APPLIANCES

(71) Applicant: NUOVA STAR S.p.A., Zola Predosa (Bologna) (IT)

(72) Inventor: Marco VANINI, Bologna (IT)

(21) Appl. No.: 14/525,779

(22) Filed: Oct. 28, 2014

(30) Foreign Application Priority Data
Nov. 29, 2013 (IT) BO2013A000663

(51) Int. Cl. E05D 3/14; A47B 96/00; E05D 15/00

(52) U.S. Cl. CPC E05D 3/14; E05D 15/00; A47B 96/00; E05D 2700/00

(57) ABSTRACT

A hinge for doors of domestic appliances such as ovens or the like, comprises a first member fixable to a frame of the domestic appliance, a second hinge member fixable to a door and kinematic connection means between the first and the second hinge member to make them tiltably movable relative to each other so that the door can move relative to the frame between a closed position and at least one open position.

This application claims priority to Italian Patent Application BO2013A000663 filed Nov. 29, 2013, the entirety of which is incorporated by reference herein.

### BACKGROUND OF THE INVENTION

This invention relates to a hinge for doors of domestic appliances.

More specifically, this invention relates to a hinge for connecting the door of a domestic appliance to the respective mounting frame.

This specification describes the present invention with reference to an oven purely by way of a non-limiting example.

The doors of domestic appliances, especially those of ovens, are often subjected to improper use, at times decidedly dangerous.

In effect, when open, an oven door makes a horizontal surface which a user might incorrectly consider to be a convenient supporting surface.

Especially in the case of ovens mounted near the floor, it is not unlikely for this “supporting surface” to be used in an extremely dangerous manner, even like a step to gain access to high kitchen shelves.

Under such extreme circumstances, given a person's average weight and the lever arm on which this weight force is applied, the oven will very likely topple over, with unpleasant consequences which are not difficult to imagine.

To avoid dangerous events of this kind, the applicant of this invention previously developed a hinge for domestic appliances which was capable of angular extra-travel through more than 90°, so that the oven door could be inclined when a weight force with a mainly vertical component was applied to it.

This and other prior art solutions, although satisfactory in many respects have not proved to be free of disadvantages.

The main disadvantages of the prior art hinges of this kind are due to their constructional complexity and to component wear.

### SUMMARY OF THE INVENTION

This invention therefore has for an aim to provide a hinge for domestic appliance doors which is capable of extra-travel beyond the normal door open position and which is free of the disadvantages of prior art hinges.

Another aim of the invention is to provide a hinge that is simple and economical to make and practical and functional to use.

The technical features of the invention, with reference to the above aims, can be easily inferred from the appended claims, in particular claim 1, and preferably any of the claims that depend, either directly or indirectly, on claim 1.

### BRIEF DESCRIPTION OF THE DRAWINGS

The advantages of the invention are more apparent from the detailed description which follows, with reference to the accompanying drawings which illustrate preferred non-limiting embodiments of it purely by way of example, and in which:

FIG. 1 is a schematic perspective view from above of an oven with a door connected to it by two hinges made in accordance with the present invention;

FIGS. 2 to 5 are schematic side elevation views, with some parts transparent, showing a first embodiment of the hinge according to the invention in four different use configurations;

FIGS. 6 to 9 are schematic side elevation views, with some parts transparent, showing a second embodiment of the hinge according to the invention in four different use configurations;

FIGS. 10 to 13 are schematic side elevation views, with some parts transparent, showing a third embodiment of the hinge according to the invention in four different use configurations.

### DESCRIPTION OF THE PREFERRED EMBODIMENTS

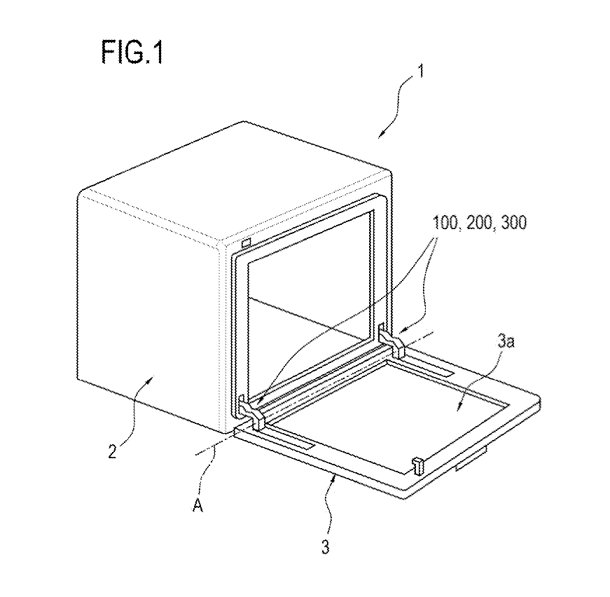

The numeral 1 in FIG. 1 denotes in its entirety an oven comprising a frame 2 to which a door 3 is connected by two hinges 100, 200, 300, illustrated schematically, which enable it to be tiltably rotated about a first, horizontal axis A.

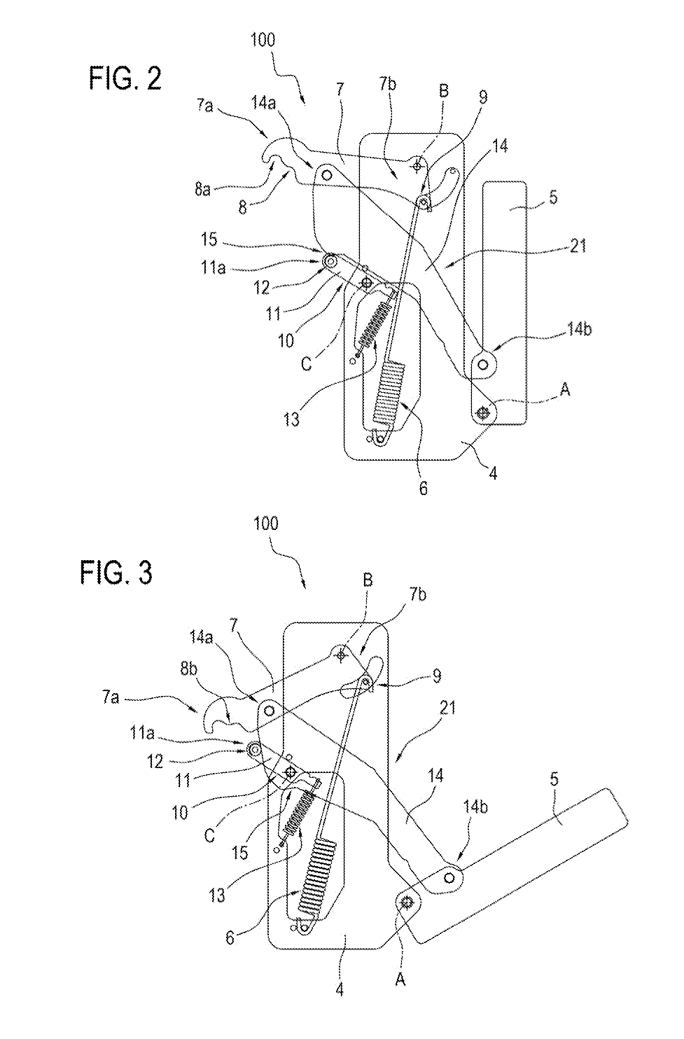

FIGS. 2 to 5 illustrate a first embodiment of the hinge according o this invention, denoted by the reference numeral 100.

Each of the two hinges 100 comprises a first member 4 fixed to the frame 2 of the oven 1 a second member 5 fixed to the door 3 and a first spring 6 designed to balance the tilt opening movement of the second hinge member 5 relative to the first hinge member 4.

With reference to FIGS. 2 to 5, the hinge 100 comprises a first rocker lever 7 pivoted to the first hinge member 4 to rock relative to it about a respective first pivoting axis B perpendicular to the placement plane of the drawings.

The first rocker lever 7 has, on opposite sides of the first pivoting axis B, a first end 7a and a second end 7b.

At its first end 7a the first rocker lever 7 has a first cam profile 8.

The first profile 8 has two concave zones separated by a convex portion 8b.

The first cam profile 8 terminates, at one end of it, with a hook-shaped portion 8a incorporating one of the two concave zones.

At its second end 7b the first rocker lever 7 has an element 9 for engaging a top end of the first spring 6.

At its bottom end, the first spring 6 is connected to the first hinge member 4.

As illustrated in FIGS. 2 to 5, the hinge 100 comprises a follower element 10 designed to engage the first cam profile 8.

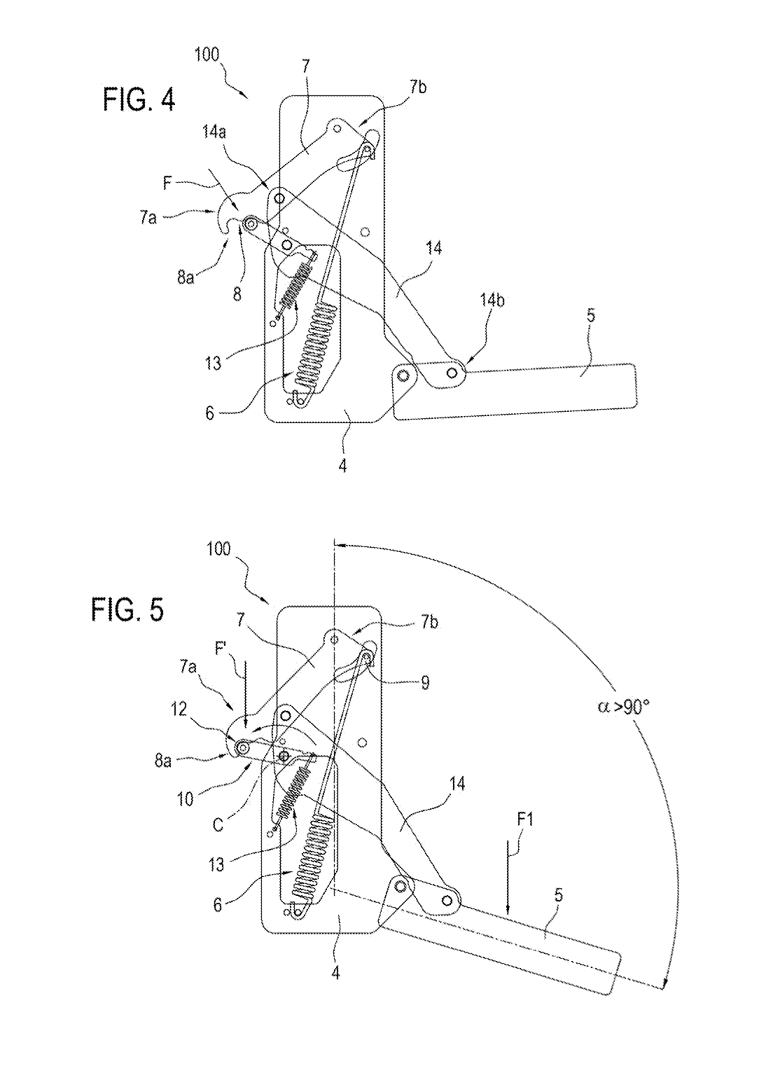

More specifically, as explained in more detail below, the follower element 10 engages the first cam profile 8 when the door has nearly reached its open position, as illustrated in FIGS. 4 and 5.

The follower element 10 comprises a rod 11 pivoted to the first hinge member 4 to rock relative to it about a second pivoting axis C and a roller 12 designed to abuttedly engage the first cam profile 8.

The roller 12 is rotatably mounted on the rod 11 at a first end 11a thereof.

The hinge 100 comprises a second spring 13 which opposes the rocking movement of the follower element 10.

The second spring 13 has two longitudinally opposite ends, one of which is connected to the rod 11 of the follower element 10 and the other is connected to the first hinge member 4.

With reference to FIGS. 2 to 5, the hinge 100 also comprises a control lever 14 for controlling the first rocker lever 7.

The control lever 14 is pivoted by its longitudinal ends 14a, 14b to the first rocker lever 7 and to the second hinge member 5, respectively.

The control lever 14 has a second cam profile 15 which is also designed to engage the follower element 10.

More specifically, as explained in more detail below, the second cam profile 15 engages the follower element 10 when the door has nearly reached its closed position, as illustrated in FIG. 2.

The above mentioned first rocker lever 7, follower element 10, control lever 14 and first spring 6 define, in their entirety for the hinge 100, respective kinematic connection means 21 between the first hinge member 4 and the second hinge member 5.

In use, in the configuration illustrated in FIG. 2, where the door 3, not illustrated, is in a closed position relative to the frame 2, also not illustrated, the follower element 10 is engaged with the second cam profile 15 of the control lever 14.

The follower element 10, thanks to the spring 13, applies to the control lever 14, and through the latter to the second hinge member 5, the closing force necessary to keep the door 3 firmly in the closed position.

FIG. 3 illustrates the hinge 100 in the configuration of it which defines an intermediate open position of the door 3. In this intermediate configuration the follower element 10 is not engaged either with the first cam profile 8 or with the second cam profile 15.

FIG. 4 illustrates the hinge 100 in the configuration of it which defines a fully open position of the door 3, in this fully open configuration the follower element 10 is engaged with the first cam profile 8.

More precisely, the roller 12 engages a concave zone of the first cam profile 8.

It is a condition of equilibrium where the weight of the door 3, not illustrated, pushes the first end 7a of the first lever 7 against the follower element 10 and applies to the latter a force which is schematically represented by an arrow F in the drawing. In this configuration, the second spring 13 is advantageously loaded and applies an opposing action.

FIG. 5 illustrates the hinge 100 in the configuration of it which defines an extra open position of the door 3. This configuration is adopted by the hinge 100 when a certain force F1 is applied to the door.

The extent of the force F1, depends on numerous factors, such as, in particular, the weight of the door 3 and the characteristics of the springs 6 and 13. For the purposes of this specification, however, it is sufficient to provide an indication of the nature of the force F1, that is to say, a force which, if applied to a flat inside surface of the door 3 in the open position, can cause the oven to topple. For precautionary reasons, the value set for the force F1 is well below that which will actually cause the oven to topple.

The above mentioned force F1 represents the effect of resting a mass on the flat inside surface 3a of the door 3. By “mass” is meant any object capable of applying a respective weight force on the door 3, even the body of a user erroneously stepping onto or attempting to step onto the door 3.

The action of the force F1 on the hinge 100 causes the door 3 to adopt the extra open position, corresponding to a respective extra open configuration of the second body 5, illustrated in FIG. 5.

Between the closed configuration of the second body 5, illustrated in FIG. 2 and corresponding to the closed position of the door 3, and its extra open configuration, illustrated in FIG. 5, there is an angle a greater than 90°.

Thanks to the extra open position of the door 3, any mass bearing down on the door 3 is made to slide off, thus eliminating the cause which would lead to the risk of the oven toppling.

Advantageously, the roller 12 of the follower element 10 is in contact with the cam profiles 8, 15 only during certain stages of the open-close cycle of the door 3, thus limiting the wear due precisely to contact between the roller 12 and the cam profiles 8 and 15

More in detail, application of the force F1 pushes the first end 7a of the first lever 7 against the follower element 10 and applies to the latter a force which is schematically represented by an arrow F′ in FIG. 5. The force F′ causes the roller 12 to overcome the obstacle constituted by the convex portion 8b of the cam profile 8 and to come into abutment against and engage the hook-shaped portion 8a.

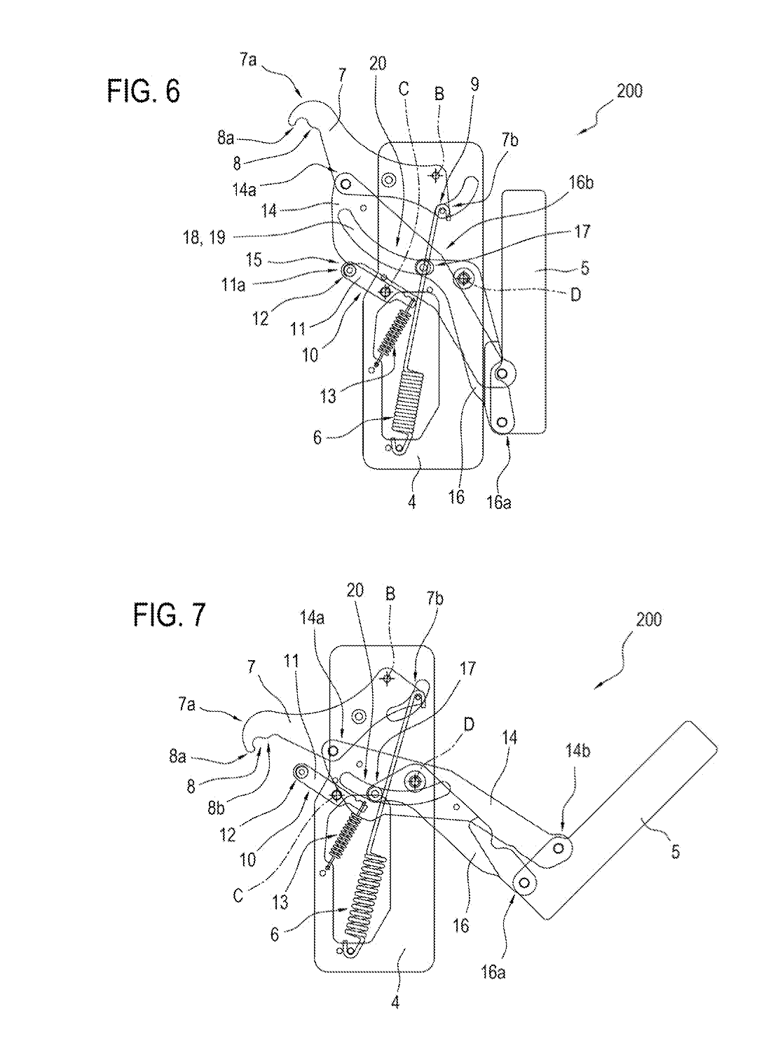

FIGS. 6 to 9 illustrate a second embodiment of the hinge according to this invention, denoted by the reference numeral 200.

The components of the hinge 200 already mentioned in the description of the hinge 100 are denoted by the same reference numerals in the following description, too.

Like the first embodiment 100 described above, the hinge 200 comprises a first member 4 fixed to the frame 2 of the oven 1, a second member 5 fixed to the door 3 and a first spring 6 designed to balance the tilt opening movement of the second hinge member 5 relative to the first hinge member 4.

With reference to FIGS. 6 to 9, the hinge 200 comprises a first rocker lever 7 pivoted to the first hinge member 4 to rock relative to it about a respective first pivoting axis B perpendicular to the placement plane of the drawings.

The first rocker lever 7 has, on opposite sides of the first pivoting axis B, a first end 7a and a second end 7b.

At its first end 7a the first rocker lever 7 has a first cam profile 8.

The first cam profile 8 terminates at one end of it, with a hook-shaped portion 8a.

At its second end 7b the first rocker lever 7 has an element for engaging a top end of the first spring 6.

At its bottom end, the first spring 6 is connected to the first hinge member 4.

As illustrated in FIGS. 6 to 9, the hinge 200 comprises a follower element 10 designed to engage the first cam profile 8.

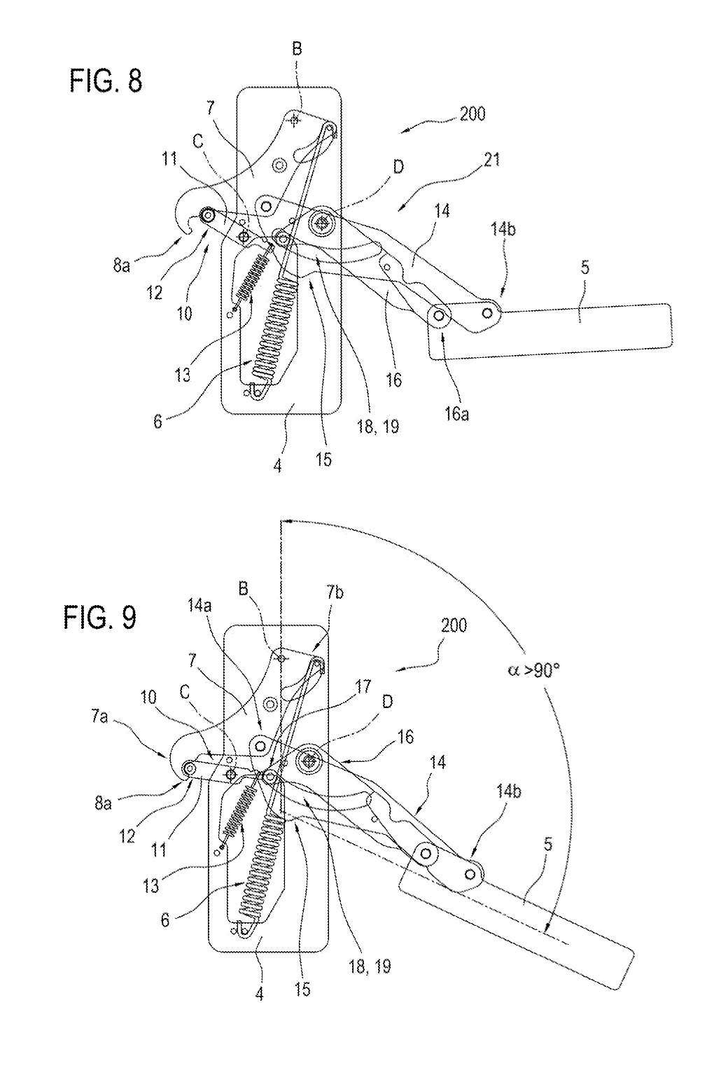

More specifically, as explained in more detail below, the follower element 10 engages the first cam profile 8 when the door has nearly reached its open position, as illustrated in FIGS. 8 and 9.

The follower element 10 comprises a rod 11 pivoted to the first hinge member 4 to rock relative to it about a second pivoting axis C and a roller 12 designed to abuttedly engage the first cam profile 8.

The roller 12 is rotatably mounted on the rod 11 at one end 11a thereof.

The hinge 200 comprises a second spring 13 which opposes the rocking movement of the follower element.

The second spring 13 has two longitudinally opposite ends, one of which is connected to the rod 11 and the other is connected to the first hinge member 4.

With reference to FIGS. 6 to 9, the hinge 200 also comprises a control lever 14 for controlling the first rocker lever 7.

The control lever 14 is pivoted by its longitudinal ends 14a, 14b to the first rocker lever 7 and to the second hinge member 5, respectively.

The control lever 14 has a second cam profile 15 which is s designed to engage the follower element 10.

More specifically, as explained in more detail below, the second cam profile 15 engages the follower element 10 when the door has nearly reached its closed position, as illustrated in FIG. 6.

The hinge 200 also comprises a second rocker lever 16.

The second rocker lever 16 is pivoted to the first hinge member 4 to rock relative to it about a respective third pivoting axis D perpendicular to the placement plane of the drawings.

The second rocker lever 16 has, on opposite sides of the third pivoting axis D, a first end 16a and a second end 16b.

At its first end 16a the second rocker ever 7 is pivoted to the second hinge member 5 attached to the door 3.

At its second end 16b the second rocker lever 16 rotatably supports a roller 17.

The roller 17, as a follower element, is designed to engage a slot 18 made in the control lever 14 and defining a third cam profile 19.

The above mentioned second hinge member 5, first rocker lever 7, second rocker lever 16 and control lever 14 together form an articulated mechanism for controlling the opening and closing movement of the door 3.

In this articulated mechanism, the third cam profile 19 and the follower constituted by the roller 17 constitute means 20 for guiding the relative movement between the second rocker lever 16 and the control lever 14.

The above mentioned first rocker lever 7, second rocker lever 16, follower element 10, control lever 14 and first spring 6 define, in their entirety for the hinge 200, respective kinematic connection means 21 between the first hinge member 4 and the second hinge member 5.

The operation of the hinge 200 illustrated in FIGS. 6 to 9 is very much the same as that described above with reference to the hinge 100 and, for the sake of brevity, the reader is referred thereto.

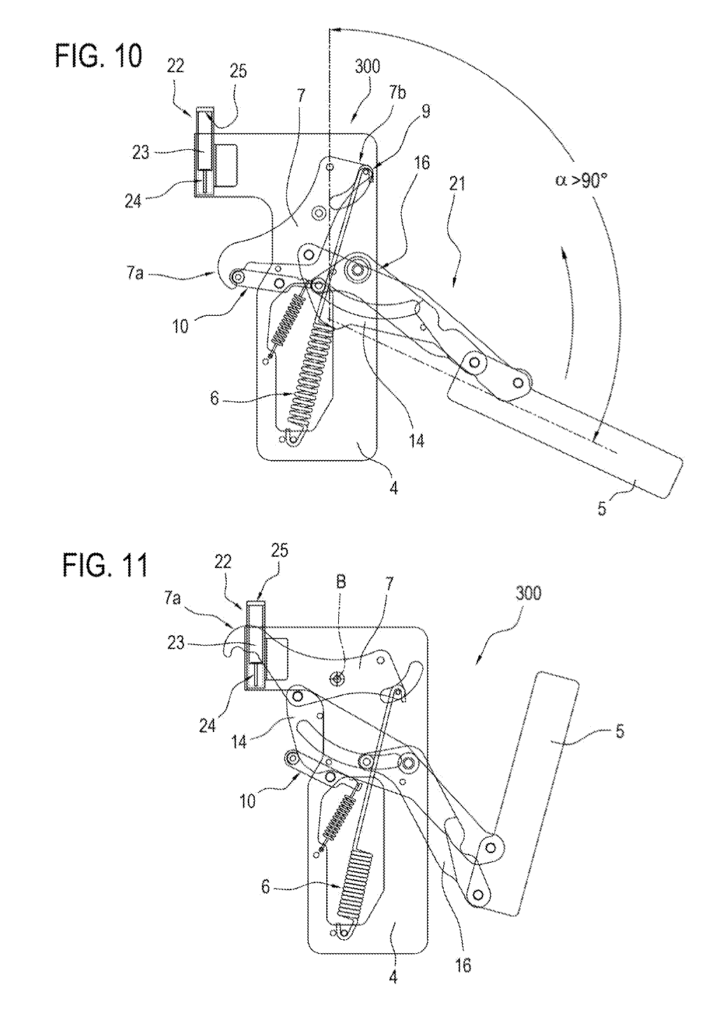

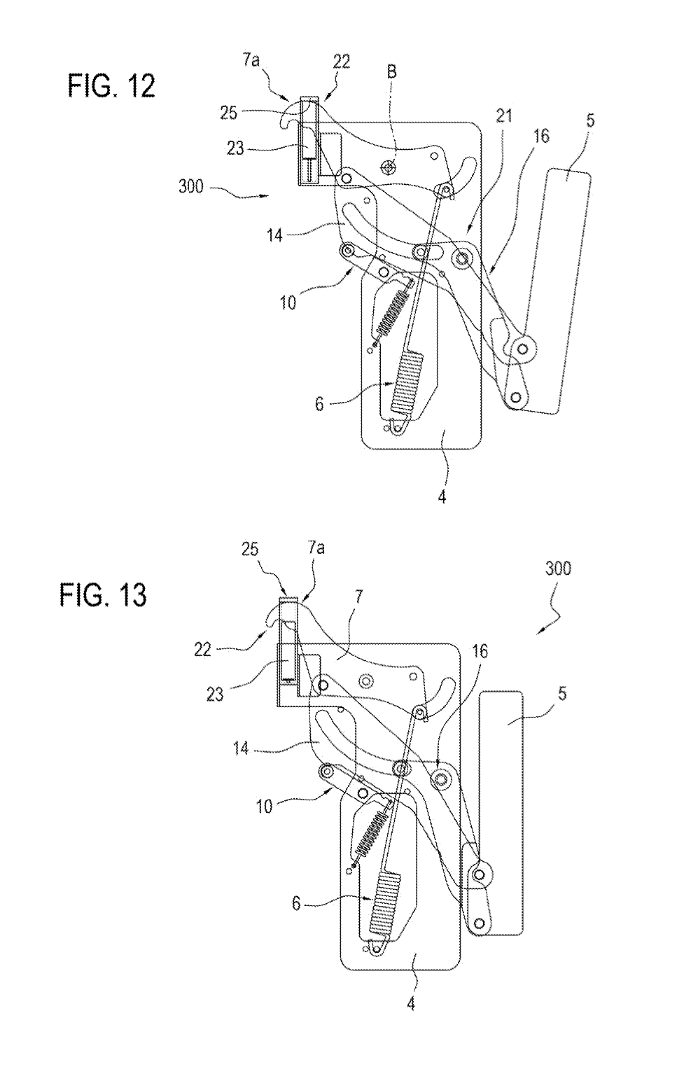

FIGS. 10 to 13 illustrate a third embodiment of the hinge according to this invention, denoted by the reference numeral 300.

The hinge 300 substantially comprises all the components of the hinge 200 which have already been mentioned in the respective description which the reader is referred to for brevity.

In addition to the components which are equivalent to those of the hinge 200, the hinge 300 comprises a damping element 22 designed to apply to the first rocker lever 7, and indirectly to the second hinge member 5 attached to the door 3, a damping action on the reciprocating motion of the first and second hinge members 4 and 5 when near to the closed position.

In the preferred but non-limiting embodiment of the hinge 300 illustrated in FIGS. 10 to 13, the damping element 22 comprises a gas or fluid cylinder 23 equipped with a linearly movable rod 24.

The damping element 22 also comprises an engagement portion 25 integral with the rod 24 against which portion 25 the first end 7a of the first rocker lever 7 is designed to abuttedly engage during the rocking movement of the first lever 7 about its first axis B.

With the exception of the aspects regarding the damping element 22, the operation of the hinge 300 illustrated in FIGS. 10 to 13 is very much the same as that described above with reference to the hinge 100 and, for the sake of brevity, the reader is referred thereto.

As clearly illustrated in FIGS. 10 to 13, which represent different configurations of the hinge 300 corresponding to the different stages in the movement of the door 3 from its extra open position, shown in FIG. 10, to its closed position, shown in FIG. 13, the first lever 7 engages the damping element 22 when near the closed position, thus causing its cylinder 23 to be compressed.

In other words, in use, when the door 3 reaches an intermediate closed position, where contact is made with the above mentioned first end 7a of the first rocker lever 7, the damping element 22, following compression of the cylinder 23, applies a damping action opposing the closing action applied by the first spring 6, thereby slowing the movement of the door 3 towards its fully closed position.

What is claimed is

1. A hinge for doors of domestic appliances such as ovens or the like, comprising a first member fixable to a frame of the domestic appliance, a second hinge member fixable to a door and kinematic connection means between the first and the second hinge member to make the first and the second member tiltably movable relative to each other so that the door can move relative to the frame between a closed position and at least one open position, the kinematic connection means comprising
a first rocker lever pivoted to the first hinge member and having a first cam profile,
a control lever for driving the first rocker lever, the control lever being pivoted at a first end of it to the second hinge member,
a follower element mounted on the first hinge member and designed to engage the first cam profile,
first elastic means for balancing a tilt opening movement of the second hinge member relative to the first hinge member, the first cam profile being shaped to determine a first and a second stopping configuration of the second hinge member, the first stopping configuration defining the open position of the door attached to the second hinge member, and the second stopping configuration defining an extra open position of the door, angularly spaced from the open position.

2. The hinge according to claim 1, wherein the kinematic connection means comprise second elastic means for opposing the movement of the follower element.

3. The hinge according to claim 1, wherein the follower element comprises a roller and a rod to which the roller is rotatably connected, the rod being designed to rock relative to the first hinge member.

4. The hinge according to claim 1, where the first rocker lever is pivoted to the first hinge member to rock about a respective first pivoting axis, wherein the first rocker lever has, at a first end of it, the first cam profile and, at a second end of it opposite to the first end, means of engagement with the first elastic means, the first and second ends being on opposite sides of the first pivoting axis.

5. The hinge according to claim 1, wherein the control lever is pivoted to the first rocker lever and wherein the control lever has a second cam profile designed to engage the follower element at least when the door is nearly at its closed position.

6. The hinge according to claim 1, wherein the second hinge member fixable to the door is pivoted directly to the first hinge member.

7. The hinge according to claim 1, wherein the kinematic connection means comprise a second rocker lever and wherein the second hinge member fixable to the door is pivoted to the second rocker lever, the second hinge member, the first and the second rocker lever and the control lever defining as a whole an articulated mechanism.

8. The hinge according to claim 7, comprising guide means for guiding the relative movement between the second rocker lever and the control lever, the guide means comprising a third cam profile defined by a slot formed on a portion of the control lever, and a follower being defined by a roller mounted on the second rocker lever and slidably coupled to the slot.

9. The hinge according to claim 1, comprising damping means mounted on the first hinge member to apply a damping action to the rocker lever at least when the door has nearly reached its closed position.

10. Use of a hinge according to claim 1 to adjust the opening/closing movement of a door of domestic appliances such as ovens or the like, characterized in that the passage of the door from the open position to the extra open position is such as to bring a flat inside surface of the door to a configuration where it is inclined to the horizontal in such a way that an object placed on it will easily slide off.

11. A domestic appliance such as an oven or the like comprising:
a frame,
a door, comprising one or more hinges according to claim 1 to connect the frame to the door and make the door tiltably movable relative to the frame between a closed position, an open position and an extra open position, between the closed position and the extra open position, there being an angle greater than 90°.
